(19) United States
(12) Patent Application Publication
(10) Pub. No.: US 2010/0256002 A1
(43) Pub. Date: Oct. 7, 2010

(54) METHOD AND APPARATUS FOR DETECTING POSITION OF DATA SPOT ON MICROARRAY

(75) Inventors: Dae-soon SON, Seoul (KR); Kyu-sang LEE, Suwon-si (KR); Kyung-hee PARK, Seoul (KR); Tae-jin AHN, Seoul (KR); Jong-suk CHUNG, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/688,938

(22) Filed: Jan. 18, 2010

(30) Foreign Application Priority Data
Apr. 6, 2009 (KR) 10-2009-0029490

(51) Int. Cl. C40B 30/00; C40B 60/12

(52) U.S. Cl. 506/7; 506/39

(57) ABSTRACT

In a method and apparatus for detecting positions of data spots on a microarray, images of the microarray are synthesized with a grid-pattern image to distinguish spots on the microarray and synthesized images are thereby generated, and a synthesized image is selected from the synthesized images based on statistics corresponding to light intensities of fiducial spots included in the synthesized images. Accordingly, the positions of the data spots are accurately detected from the selected synthesized image, and the data of the microarray is thereby analyzed.

### CROSS-REFERENCE TO RELATED APPLICATION

This application claims priority to Korean Patent Application No. 10-2009-0029490, filed on Apr. 6, 2009, and all the benefits accruing therefrom under 35 U.S.C. §119, the content of which in its entirety is herein incorporated by reference.

### BACKGROUND

1) Field

The following description relates to a method and apparatus for detecting positions of data spots on a microarray.

2) Description of the Related Art

Recently, microarrays are being increasingly used in deoxyribonucleic acid (“DNA”) analysis and other similar analyses. Conventional microarrays have a structure in which several hundreds to several tens of thousands of probe materials, whose base sequences are well known, are disposed on a plurality of predetermined spots on a substrate. In microarrays, a target material to be analyzed shows specific reactions with the probe materials corresponding to the types of probe materials. Thus, analysis of a target material using such a microarray is being studied. In a microarray, a probe material and a target material are nucleic acid materials having complementary sequences. In target material analysis using microarrays, images of microarrays are typically used. Since data corresponding to an image of a microarray is large, and several hundreds to several tens of thousands of data spots are disposed on the microarray at high density, a change in the positions of areas to which probe materials are disposed (hereinafter, referred to as “data spots”), non-uniformity of the shapes and sizes of the data spots, and the like occur during microarray image composition. Accordingly, detection of precise positions of the data spots that react with a target material is required.

### SUMMARY

One or more aspects of the present invention include a method and apparatus which accurately detects positions of data spots of a microarray without being affected by various problems, such as a change in positions of data spots, nonuniformity of the shapes and sizes of the data spots, and other similar problems. One or more aspects also include a computer program product including a computer readable computer program code for executing the method.

In one or more aspects, a method of detecting positions of data spots on a microarray includes generating synthesized images by synthesizing each of images of the microarray with a grid-pattern image to distinguish spots on the microarray, selecting a synthesized image from the synthesized images based on statistics corresponding to light intensities of fiducial spots included in the synthesized images and detecting the positions of the data spots based on the synthesized image selected from the synthesized images.

In one or more aspects, a computer program product including a computer readable computer program code for executing a method of detecting positions of data spots on a microarray, the method including generating synthesized images by synthesizing images of the microarray with a grid-pattern image to distinguish spots on the microarray, selecting a synthesized image from the synthesized images based on statistics corresponding to light intensities of fiducial spots included in the synthesized images and detecting the positions of the data spots based on the synthesized image selected from the synthesized images.

In one or more aspects, an apparatus for detecting positions of data spots on a microarray includes an image synthesis unit which synthesized images of the microarray with a grid-pattern image to distinguish spots on the microarray and generate synthesized images; a selection unit which selects a synthesized image from the synthesized images based on statistics corresponding to light intensities of fiducial spots included in the synthesized images and an output unit which detects the positions of the data spots from the synthesized image selected by the selection unit.

### BRIEF DESCRIPTION OF THE DRAWINGS

These and/or other aspects will become more apparent by describing in further detail of one or more embodiments of the general inventive concept, with reference to the accompanying drawings, in which:

FIG. 1 is a plan view illustrating an embodiment of a microarray;

FIG. 2 is a block diagram illustrating an embodiment of an apparatus for detecting positions of data spots of a microarray;

FIG. 3 is a block diagram of a selection unit included in the apparatus illustrated in FIG. 2;

FIG. 4 is a flowchart of an embodiment of a method of detecting positions of data spots of a microarray;

FIG. 5 is a flowchart of a synthesized image selecting operation included in the method illustrated in FIG. 4;

FIG. 6 is a flowchart of an embodiment in which a T-test statistic and a coefficient of variation are applied to operations illustrated in FIG. 5;

FIGS. 7A and 7B are plan views that illustrate an embodiment of a single panel within a microarray and an image of a reference file;

FIG. 8A is a plan view that illustrates an embodiment of a synthesized image detected from a single panel in which positions of data spots are accurately;

FIG. 8B is a plan view that illustrates an embodiment of a synthesized image detected from a single panel in which positions of data spots are inaccurately;

FIG. 9 is a graph illustrates a T-value of a T-test statistics calculated in an embodiment of a calculation unit included in the apparatus illustrated in FIG. 2;

FIGS. 10A and 10B are graphs illustrates coefficients of variations of light intensities of bright fiducial spots and dark fiducial spots calculated in an embodiment of the calculation unit included in the apparatus illustrated in FIG. 2; and

FIG. 11 is an embodiment of a reference file.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

One or more embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

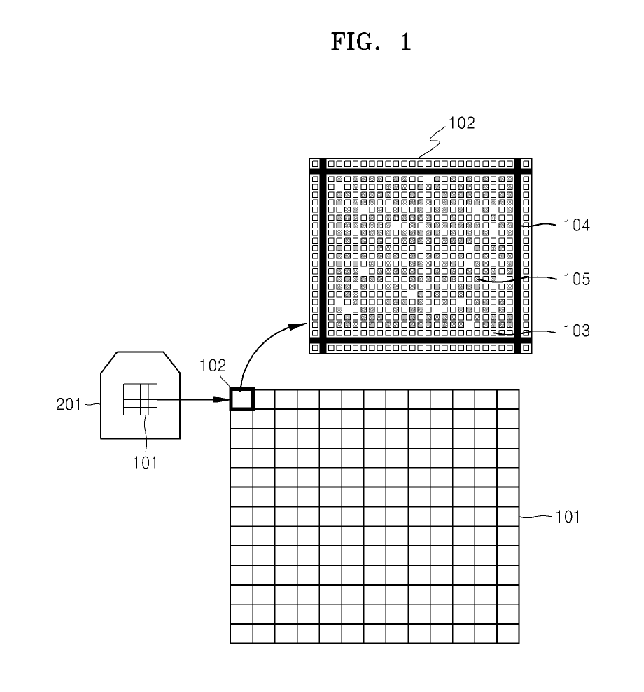

FIG. 1 is a plan view that illustrates an embodiment of a microarray 101 included in a microarray unit 201. As shown in FIG. 1, the microarray 101 includes a substrate and probe materials, e.g., several hundreds to several tens of thousands of probe materials, disposed on data spots 105, which are disposed on the substrate. The probe materials may be biomaterials having cells whose functions are well known, such as, deoxyribonucleic acid (“DNA”), ribonucleic acid (“RNA”), complementary DNA (“cDNA”), messenger RNA (“mRNA”), protein, sugar or other similar type of materials, for example. The substrate of the microarray 101 may include a material such as glass, quartz, silicon, plastic, or other similar type of materials, for example, and an oxide film that is disposed naturally or arbitrarily.

When a target material, which is analyzed, contacts the microarray 101, the target material is combined with and reacts with probe materials having a sequence complementary to a sequence of the target material from among the several hundreds or several tens of thousands of probe materials disposed on the data spots 105 on the substrate of the microarray 101. When the target material reacts with the probe materials, different degrees of hybridization may appear according to degrees of complementarity between the target material and each of the probe materials. Since the base sequences of probe materials in the data spots 105 of the microarray 101 are known when the microarray 101 is manufactured, gene information and other similar information of the target material may be easily ascertained by determining reacting spots of the data spots 105 of the microarray 101 which the probe materials reacted with the target material are disposed on.

When determining reacting spots of the data spots 105 which the probe materials reacted with the target material are disposed on, a fluorescent signal may be used. In an embodiment, a fluorescent material, which is excited by excitation light and emits a color, is labeled on the target material. The fluorescent signal is obtained by reacting the target material, on which the fluorescent material is labeled, with the microarray 101, radiating excitation light to the fluorescent material, and measuring light emitted from the fluorescent material. Data spots 105 having probe materials reacted with the target material may be detected by analyzing an image obtained from the fluorescent signal. Light intensity of the fluorescent signal represents the degree of hybridization caused by the reactions between the probe materials and the target material. In an embodiment, the greater the light intensity of the fluorescent signal is, the greater the degree of the complementarity between the probe materials and the target material is. The light intensity of the fluorescent signal may be digitalized and expressed in numerals.

Referring to FIG. 1, positions of the data spots 105 of the microarray 101 are detected in units of panels 102 using a scanner, a camera or other similar devices. Here, each of the panels 102 denotes an area in which a detector reads a fluorescent signal from the microarray 101 that has reacted with the target material. When a position of each of the data spots 105 on an image appeared on each panel 102 is accurate, a target material that has reacted with probe materials of the corresponding data spot 105 may be accurately analyzed. When the positions of the data spots 105 are accurate, which spots of the data spots 105 has reacted with which target material may be ascertained by analyzing the light intensity of a fluorescent signal detected from the each of the panels 102. It will be understood that once the positions of data spots 105 are detected from a panel by checking the positions, shapes, or other similar properties of fiducial spots, positions of data spots 105 disposed on a panel may be detected based on detected positions of the data spots 105 disposed on a previous panel.

The fiducial spots set in the microarray 101, positions of the fiducial spots detected from an image of a panel 102, and the positions of data spots 105 detected based on the detected positions of the fiducial spots will now be described according to an embodiment which accurately detects the positions of the data spots 105.

Referring to FIG. 1, a panel 102 on the microarray 101 includes data spots 105, bright fiducial (“BF”) spots 103, and dark fiducial (“DF”) spots 104. Hereinafter, the BF spots 103 and the DF spots 104 are collectively referred to as “fiducial spots.”

The data spots 105 may include same probe materials. In one or more embodiments, the data spots 105 may include different types of probe materials according to user's selections. The data spots 105 may be disposed in various shapes on the panel 102. Accordingly, the user may dispose the data spots 105 in various shapes such as a rectangle or a discrete shape, for example.

The BF spots 103 and the DF spots 104 may be used to detect the positions of the data spots 105 existing in the microarray 101. Referring to FIG. 1, the fiducial spots are used as a criterion for interpreting fluorescence signals that are generated due to reactions between the probe materials existing in the data spots 105 and a target material. A use of the fiducial spots to detect the positions of the data spots 105 will be described later.

The light intensities, positions, and other similar properties of the BF spots 103 and the DF spots 104 included in the microarray 101 may be predetermined during the manufacture of the microarray 101. The BF spots 103 may have light intensities higher than light intensities measured from fluorescent signals generated due to reactions between the target material and the probe materials of the data spots 105. The DF spots 104 may have light intensities lower than the light intensities measured from the fluorescent signals generated due to the reactions between the target material and the probe materials of the data spots 105. The light intensities of the DF spots 104 may be zero (0). The BF spots 103 and the DF spots 104 may be set to have predetermined positions and shapes by the user during the manufacture of the microarray 101. Therefore, it will be understood that the light intensities or the positions of the BF spots 103 and the DF spots 104 may be easily controlled according to user's selections.

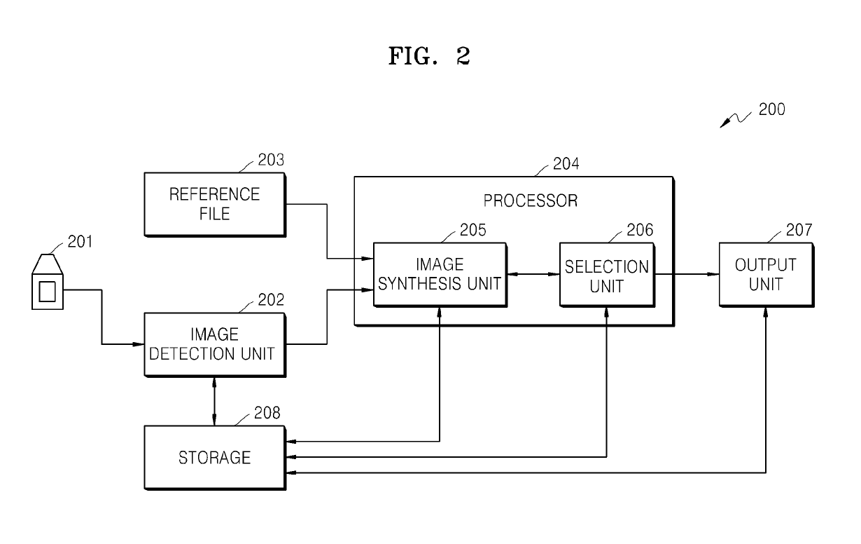

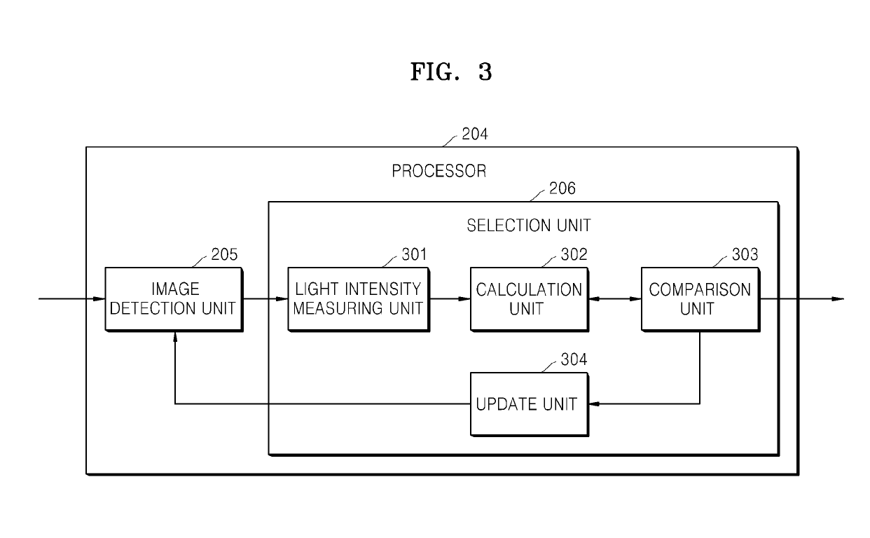

FIG. 2 is a block diagram illustrating an embodiment of an apparatus for detecting the positions of data spots of a microarray 200. As shown in FIG. 2, the apparatus for detecting the positions of the data spots of the microarray 200 includes the microarray unit 201, having the microarray 101 (FIG. 1) disposed therein, an image detection unit 202, a processor 204, a storage 208 and an output unit 207. The processor 204 includes an image synthesis unit 205 and a selection unit 206. The selection unit 206 includes a light intensity measuring unit 301 (FIG. 3), a calculation unit 302 (FIG. 3), a comparison unit 303 (FIG. 3), and an update unit 304 (FIG. 3). The processor 204 including the image synthesis unit 205 and the selection unit 206 may be implemented with an array of logic gates or a combination of a specific- or general-use microprocessor and a memory device including programs stored therein to be executed in the specific- or general-use microprocessor. It will be understood that the processor 204 may be implemented with various other types of hardware. Although only hardware components related with the embodiment have been described for a simple and clear description of the present embodiment, it will be understood that general-use hardware components other than the hardware components illustrated in FIG. 2 may be included in the apparatus for detecting the positions of the data spots of the microarray 200. It will also be understood that other devices such as an apparatus for detecting the positions of data spots of the microarray 200 or analyzing data of the microarray 201 may be easily implemented by selecting and combining one or more of the above-described units.

The image detection unit 202 detects an image from each panel using light that is reflected from the microarray 201 after light is radiated into the microarray 201 reacted with a target material. The light radiated to the microarray 201 may be laser light or any light having a wavelength. In an embodiment, an image corresponds to a fluorescent signal obtained by reacting the microarray 201 with a target material on which a fluorescent material is labeled, radiating excitation light to the target material to excite the fluorescent material, and measuring light emitted from the fluorescent material. When the image detection unit 202 detects the image, a light-receiving device which measures fluorescence or other similar features of light may be used. For example, a photomultiplier tube, a photodiode, a charged-couple device (“CCD”), or other similar devices may be used as the light-receiving device. The image detection unit 202 may include an apparatus for detecting images such as a scanner or a camera, for example, and it will be understood that other devices may be used as the apparatus for detecting images.

The image synthesis unit 205 synthesizes each of images of the microarray 201 with a grid-pattern image which distinguishes spots from one another on the microarray 201 (hereinafter, referred to as “a reference file image”). A reference file 203 denotes a file including information about probe materials disposed on the data spots 105 during the manufacture of the microarray 201 and information about BF spots 103 and DF spots 104. In an embodiment, the reference file 203 may include, for example, information about a sequence of bases that constitute a probe material and a sequence of bases that constitute a target material that reacts with the probe material, and information about light intensity of a fluorescent signal that is generated from the position of a probe material after a reaction between the probe material and the target material.

The reference file 203 includes a grid-pattern image, which distinguishes the spots on a microarray image detected by the image detection unit 202, and a document file including information recorded thereon about position, shape, light intensity and other similar properties of each of the spots.

The document file may further include coordinates allocated to the positions of the data spots 105, the BF spots 103 and the DF spots 104. It will also be understood that the reference file 203 may include data other than the above-described data.

In an embodiment, one of the images of the microarray 201, which the image synthesis unit 205 synthesizes, is an image detected from the image detection unit 202, and others of the images of the microarray 201 are images obtained by moving the one of the images to different positions. Each of the images of the microarray 210 is synthesized with the reference file image.

The different positions may be set by a user by considering usage environments. The different positions may be set to be different by referring to the coordinates of the spots of the reference file image. The different positions may include all of the positions existing on a single panel where the one of the images is moved. In an embodiment, the image synthesis unit 205 moves the one of the images vertically, horizontally or diagonally, and synthesizes the image at different locations with the reference file image.

The storage 208 stores images detected by the image detection unit 202 and synthesized images obtained by the image synthesis unit 205. When a reference synthesized image is set from among the synthesized images, the reference synthesized image is also stored in the storage 208. The storage 208 also stores results of operations performed in the selection unit 206. In an embodiment, the storage 208 stores a result of the measurement performed in the light intensity measuring unit 301 of FIG. 3 included in the selection unit 206, a result of the calculation performed in the calculation unit 302 of FIG. 3 included in the selection unit 206, a result of the comparison performed in the comparison unit 303 of FIG. 3 included in the selection unit 206, a result of the update performed in the update unit 304 (see FIG. 3) included in the selection unit 206, and the like. When the storage 208 is updated by the update unit 304, updated synthesized images or an updated set reference synthesized image are transmitted to the selection unit 206.

FIG. 3 is a block diagram of the selection unit 206 included in the apparatus illustrated in FIG. 2. As shown in FIG. 3, the selection unit 206 includes the light intensity measuring unit 301, the calculation unit 302, the comparison unit 303 and the update unit 304. The selection unit 206 selects one synthesized image from among the synthesized images obtained by the image synthesis unit 205 on the basis of statistics corresponding to the light intensities of fiducial spots included in the synthesized images.

The light intensity measuring unit 301 measures light intensities of the positions of BF spots, DF spots, and data spots displayed on the reference file image in the synthesized images obtained by the image synthesis unit 205. In an embodiment, the light intensity measuring unit 301 measures the light intensities by setting coordinates to the light intensities by referring to the coordinates stored in the reference file 203.

The calculation unit 302 calculates the statistics corresponding to the light intensities of the synthesized images measured in the light intensity measuring unit 301. The statistics include at least one of statistics corresponding to standardized differences between the light intensities measured from the positions of the fiducial spots and statistics corresponding to uniformity of the light intensities measured from the positions of the fiducial spots.

A reason for calculation of the statistics corresponding to the light intensities of the positions of the fiducial spots of the reference file image will now be described in further detail. When the positions of data spots of a synthesized image are accurately detected, the fiducial spots on a reference file image included in the synthesized image are not overlapped by data spots on an actual microarray image included in the synthesized image or fiducial spots on the actual microarray image that have light intensities different from the light intensities of the fiducial spots on the reference file image. Thus, the light intensities of the fiducial spots of the reference file image included in the synthesized image are equal to or slightly different from the light intensities of corresponding positions recorded in the reference file 203. Therefore, a difference between the light intensities of the positions of the BF spots and the light intensities of the positions of the DF spots of the reference file image of the synthesized image is the largest as compared with other synthesized images. Since the light intensities of the positions of the BF spots and the positions of the DF spots are slightly different from or equal to the light intensities of corresponding positions recorded in the reference file 203, variations of the light intensities are small.

On the other hand, when the positions of data spots of a synthesized image are inaccurately detected, the fiducial spots of a reference file image included in the synthesized image are overlapped by data spots on an actual microarray image included in the synthesized image or fiducial spots on the actual microarray image that have light intensities different from the light intensities of the fiducial spots on the reference file image. Thus, since the position of the BF spots of the reference file image included in the synthesized image may be overlapped by the positions of the data spots or the positions of the DF spots on an actual microarray image that have lower light intensities than the light intensities that the BF spots have, the measured light intensities of the position of the BF spots of the reference file image included in the synthesized are lower than the light intensities recorded in the reference file 203. Similarly, since the position of the DF spots of the reference file image included in the synthesized image may be overlapped by data spots or BF spots on an actual microarray image that have higher light intensities than the DF spots, the measured light intensities of the positions of the DF spots of the reference file image included in the synthesized image are higher than the light intensities of corresponding positions recorded in the reference file 203. Therefore, a difference between the light intensities of the positions of the BF spots and the light intensities of the positions of the DF spots of the reference file image is decreased, and a variation of the light intensities of the BF or the light intensities of the DF spots is increased. As a result, the positions of the data spots actually formed on the microarray 201 may not coincide with the positions of the data spots on the reference file image, and thus a target material may not be accurately analyzed when signals obtained from the data spots are analyzed.

Thus, the calculation unit 302 calculates statistics corresponding to a standardized difference between the light intensities of BF spots and the light intensities of DF spots to search for an image having the largest difference between the light intensities of the BF spots and the light intensities of the DF spots. The calculation unit 302 also calculates statistics corresponding to uniformity between the light intensities of the BF spots or uniformity between the light intensities of the DF spots to search for a synthesized image having the smallest degree of variation in the light intensities of the BF spots or the DF spots.

The calculation unit 302 may calculate a standardized difference between the light intensities measured by the light intensity measuring unit 301 using a T-test statistic. In an embodiment, the calculation unit 302 first calculates a mean, a dispersion, a standard deviation, and other similar statistical quantities of the light intensities measured from the positions of the fiducial spots, and calculates the T-test statistic using the mean, the dispersion, the deviation, and the other similar statistical quantities of the light intensities.

A Student's T-test is a statistical method that is used to ascertain whether a difference between the means of two groups is statistically significant. Student's T-tests are classified into a single sample T-test, an independent sample T-test, and other similar T-tests. The single sample T-test is used to check whether the mean of a single population is different from a reference value. The independent sample T-test is used to test a difference between the means of two independent groups with respect to a single test variable. In an embodiment, since BF spots and DF spots correspond to the two independent groups and a light intensity corresponds to the single test variable, the independent sample T-test may be used. In an embodiment, the independent sample T-test may be performed using the T-test statistic. The independent sample T-test is a well-known statistical method, and thus a detailed description thereof will be omitted.

The calculation unit 302 calculates the T-test statistic. To obtain a standardized difference between the light intensities of the BF spots and the light intensities of the DF spots, a mean of the light intensities of the BF spots and a mean of the light intensities of the DF spots are first calculated. Generally, the mean corresponds to a representative value that represents a population. In an embodiment, the mean of the light intensities of the BF spots and the mean of the light intensities of the DF spots correspond to a representative value of the light intensities of the BF spots and a representative value of the light intensities of the DF spots, respectively. However, if the light intensities of each of the BF spots and the DF spots do not form a normal distribution, a mean of the light intensities is not a representative value because the mean may be affected by extreme data included in the light intensities. Therefore, a standardized difference between means of light intensities is used. In an embodiment, to obtain the standardized difference between the means of light intensities, the T-test statistic may be calculated using Equation 1:

$$T = \frac{{\overline{X}}_{BF} - {\overline{X}}_{DF}}{\sqrt{\frac{{S}_{BF}^{2}}{{n}_{BF}} + \frac{{S}_{DF}^{2}}{{n}_{DF}}}} \qquad ( 1 )$$

where the T test statistic T is a value obtained by dividing a mean difference between two groups by a standard error and standardizing a result of the division, X̅_{BF} denotes a mean of light intensities of the positions of BF spots displayed on the reference file image, X̅_{DF} denotes a mean of light intensities of the positions of DF spots, displayed on the reference file image, S_{BF} denotes a standard deviation of the light intensities of the positions of the BF spots, S_{DF} denotes a standard deviation of the light intensities of the positions of the DF spots, n_{BF} denotes the number of light intensities of the positions of the BF spots, and n_{DF} denotes the number of light intensities of the positions of the DF spots. In an embodiment, the T-test statistic, which is a standardized difference between the light intensities of the positions of the BF spots and the light intensities of the positions of the DF spots, may be calculated using Equation 1. Accordingly, an image having the largest standardized difference between the light intensities of the BF spots and the light intensities of the DF spots may be searched from among the synthesized images obtained by the image synthesis unit 205 based on the calculated standardized difference.

The calculation unit 302 may calculate the statistics corresponding to the uniformity between the light intensities measured by the light intensity measuring unit 301 using a coefficient of variation (“CV”). In an embodiment, the calculation unit 302 calculates a mean, a dispersion, a deviation and other similar statistical quantities of the light intensities measured from the positions of the BF spots, and calculates the CV using the mean, the dispersion, the deviation and the other similar statistical quantities of the light intensities of the BF spots. Similarly, the calculation unit 302 calculates a mean, a dispersion, a deviation and other similar statistical quantities of the light intensities measured from the positions of the DF spots, and calculates the CV using the mean, the dispersion, the deviation and the other similar statistical quantities of the light intensities of the DF spots

In general, a CV measures a variation of data in a single group, and is obtained by dividing a standard deviation of the data by a mean thereof. In an embodiment, when a value of the CV is small, the variation of the data is small and the characteristics of the data are uniform because, as described above, when the positions of the data spots of a microarray are inaccurately detected, the CV of the light intensities of the positions of the BF spots on the reference file image increases as compared with when the positions of the data spots of a microarray are accurately detected, and similarly the CV of the light intensities of the positions of the DF spots on the reference file image increases. In an embodiment, data spots having light intensities different from those of the BF and DF spots, or other fiducial spots having different light intensities may be located at the positions of the BF and DF spots.

To obtain the CV of the light intensities of the BF spots and the CV of the light intensities of the DF spots, a mean and a standard deviation of the light intensities of each of the BF spots and the DF spots are calculated. The CV of the light intensities of the BF spots and the CV of the light intensities of the DF spots may be obtained using at least one of Equation 2 and Equation 3:

$${CV}_{BF} = \frac{{S}_{BF}}{{\overline{X}}_{BF}} \qquad ( 2 )$$

where S_{BF} denotes the standard deviation of the light intensities of the positions of the BF spots displayed on the reference file image, and X̅_{BF} denotes the mean of the light intensities of the positions of the BF spots. Accordingly, a CV of the light intensities of the positions of the BF spots, CV_{BF}, may be calculated using the standard deviation S_{BF} and the mean X̅_{BF}; and

$${CV}_{DF} = \frac{{S}_{DF}}{{\overline{X}}_{DF}} \qquad ( 3 )$$

where S_{DF} denotes the standard deviation of the light intensities of the positions of the DF spots displayed on the reference file image, and X̅_{DF} denotes the mean of the light intensities of the positions of the DF spots. Accordingly, a CV of the light intensities of the positions of the DF spots, CV_{DF} may be calculated using the standard deviation S_{DF} and the mean X̅_{DF}. Therefore, an image having the smallest CV of the light intensities of the positions of the BF spots and the smallest CV of the light intensities of the positions of the DF spots may be found from the synthesized images obtained by the image synthesis unit 205. When a CV is effectively small, the light intensities are substantially uniform. A CV described hereinafter includes at least one of a CV corresponding to the BF spots and a CV corresponding to the DF spots.

Although a method used in the calculation unit 302 which uses T-test statistic and a CV will now be described as an example, it will be understood that other methods of calculating a statistic corresponding to a standard difference or uniformity may be used.

The comparison unit 303 compares the synthesized images to one another with respect to their statistics corresponding to the light intensities of fiducial spots. Based on a result of comparisons performed in the comparison unit 303, the selection unit 206 selects a synthesized image having at least one of a statistic corresponding to the largest difference between light intensities and a statistic corresponding to the greatest uniformity between light intensities from among the synthesized images. The selected synthesized image is transmitted to the output unit 207. In an embodiment of the comparison unit may compare a reference synthesized image with some of the synthesized images. In another embodiment of the comparison unit may compare all of the synthesized images to one another.

In an embodiment, as described above, the reference synthesized image from among the synthesized images obtained by the image synthesis unit 205 is compared with some of synthesized images.

The reference synthesized image is set as an initial target for comparisons performed in the comparison unit 303 because when the reference synthesized image is selected based on a result of comparisons performed in the comparison unit 303, the comparison is no longer performed and the positions of data spots on the reference synthesized image are detected.

The reference synthesized image initially set is a synthesized image from among the synthesized images obtained by the image synthesis unit 205 obtained by synthesizing the image detected by the image detection unit 202 with the reference file image. However, the reference synthesized image initially set is not limited thereto, and may be a synthesized image obtained by synthesizing an image obtained by moving the detected image with the reference file image.

The comparison unit 303 compares the statistics of the reference synthesized image with the statistics of some of the synthesized images. The reference synthesized image and the some of the synthesized images are obtained by the image synthesis unit 205. The number of the some of the synthesized images may vary according to usage environments and correspond to the number of synthesized images to be compared with the reference synthesized image. For example, when the number of some synthesized images is 16, 16 synthesized images may be obtained by moving the image detected by the image detection unit 202 to 16 different positions with the reference file image from among the synthesized images. In other words, the number of some synthesized images may be easily set by a user according to the usage environments.

Based on a comparison between the reference synthesized image and each of the some synthesized images, when the reference synthesized image has at least one of a statistic indicating that a difference between the light intensities of BF spots and the light intensities of DF spots is the largest and a statistic indicating that the light intensities of each of the BF spots and the DF spots are the most uniform, the selection unit 206 selects the reference synthesized image. The selected reference synthesized image is transmitted to the output unit 207.

On the other hand, when a synthesized image other than the reference synthesized image has at least one of a statistic indicating that a difference between the light intensities of BF spots and the light intensities of DF spots is the largest and a statistic indicating that the light intensities of each of the BF spots and the DF spots are the most uniform, the update unit 304 updates the reference synthesized image with the other synthesized image.

The update unit 304 substitutes the reference synthesized image with another synthesized image, as described above, and updates the reference synthesized image stored in the storage 208 with the other synthesized image.

The update unit 304 updates the some of the synthesized images, which have already compared with a previous reference synthesized image, with synthesized images obtained by synthesizing some of the images of the microarray 201 obtained based on a new reference synthesized image with the reference file image. The images of the microarray 201 obtained based on the new reference synthesized image with the reference file image are images obtained by moving an image of the microarray 201 synthesized with the reference file image to obtain an updated reference synthesized image to different positions. In an embodiment, the image synthesis unit 205 synthesizes images of the microarray 201 updated by the update unit 304 and obtained by moving the image of the microarray 201 synthesized with the reference file image to different positions with the reference file image, and updates the some of the synthesized images, which have already compared with the previous reference synthesized image, with new synthesized images. Similarly, the update unit 304 updates the synthesized images stored in the storage 208.

The selection unit 206 repeatedly performs obtaining the new synthesized images, operations of measuring light intensities, calculating statistics corresponding to the measured light intensities, comparing the calculated statistics of the updated synthesized images from one another, and performing update according to a result of the comparison until the updated reference synthesized image has at least one of a statistic indicating that a difference between light intensities is the greatest and a statistic indicating that light intensities are the most uniform.

In another embodiment, all of the synthesized images obtained by the image synthesis unit 205 are compared with one another, a reference synthesized image is not set and one synthesized image is selected from all of the synthesized images and transmitted to the output unit 207.

In an embodiment, the comparison unit 303 compares the statistics of all of the synthesized images obtained by the image synthesis unit 205 with one another, and the comparison unit 303 selects a synthesized image having at least one of a statistic indicating that a difference between light intensities is the greatest and a statistic indicating that light intensities are the most uniform from among all of the synthesized images. The selected synthesized image is transmitted to the output unit 207.

The output unit 207 detects the positions of data spots of a selected synthesized image selected in the selection unit 206. The output unit 207 reads an image of the microarray 201 synthesized with the reference file image to obtain the selected synthesized image from the storage 208 and detects the positions of the data spots on the basis of the positions of fiducial spots of the selected synthesized image.

In analysis of a target material using the microarray 201, information about the target material is analyzed based on fluorescent signals of the data spots on the basis of the positions of the data spots, which are detected by the output unit 207.

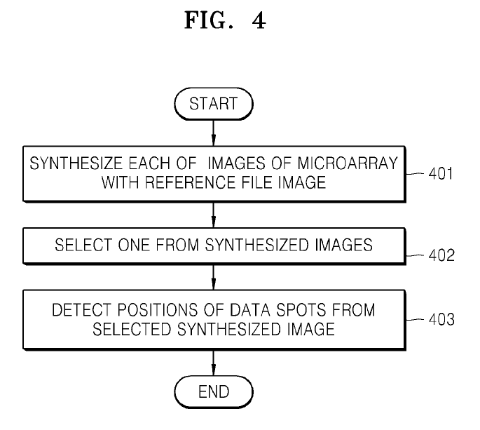

FIG. 4 is a flowchart of an embodiment of a method of detecting positions of data spots of the microarray 201. The method of FIG. 4 includes operations performed in one or more embodiment of the apparatus for detecting the positions of the data spots of the microarray 200 illustrated in FIGS. 2 and 3.

In operation 401, the image synthesis unit 205 synthesizes each of the images of the microarray 201 with the reference file image.

In operation 402, the selection unit 206 selects one from the synthesized images obtained by the image synthesis unit 205 on the basis of the statistics corresponding to the light intensities of fiducial spots included in the synthesized images.

In operation 403, the output unit 207 detects the positions of the data spots from the synthesized image selected by the selection unit 206.

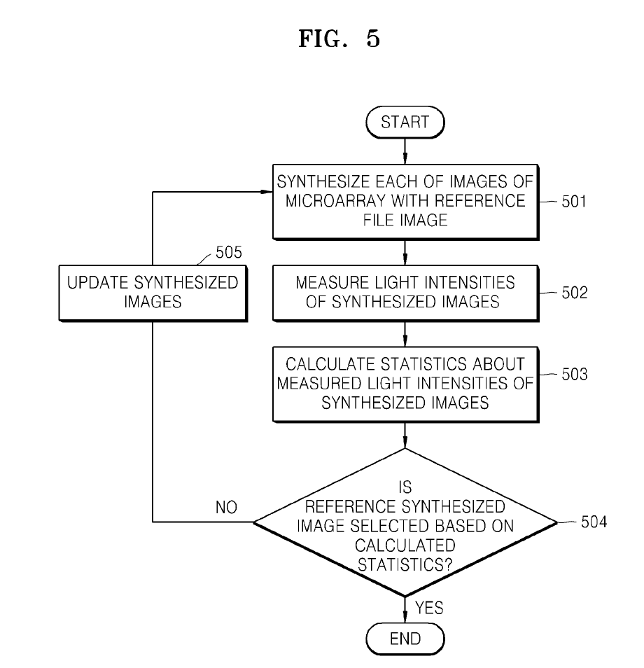

FIG. 5 is a flowchart of a synthesized image selecting operation 402 included in the method illustrated in FIG. 4. The operation 402 includes suboperations performed in the selection unit 206 illustrated in FIGS. 2 and 3.

In operation 501, the image synthesis unit 205 synthesizes each of the images of the microarray 201 with the reference file image.

In operation 502, the light intensity measuring unit 301 measures light intensities of the positions of BF spots of the reference file image, light intensities of the positions of DF spots of the reference file image, and light intensities of the positions of data spots of the reference file image in the synthesized images obtained by the image synthesis unit 205. In operation 502, the light intensity measuring unit 301 may measure all of the synthesized images stored in the storage 208 as described above.

In operation 503, the calculation unit 302 calculates the statistics corresponding to the light intensities of the synthesized images, which are measured by the light intensity measuring unit 301.

In operation 504, the comparison unit 303 compares the synthesized images with one another with respect to their statistics corresponding to the light intensities of fiducial spots. Based on the comparison, the selection unit 206 selects a synthesized image having at least one of a statistic corresponding to the largest difference between light intensities and a statistic corresponding to the greatest uniformity between light intensities from among the synthesized images.

In operation 505, the update unit 304 sets a new reference synthesized image as described above and updates the some synthesized images, which have already compared with the previous reference synthesized image, with some of the synthesized images obtained by synthesizing some of images of the microarray 201 corresponding to the new reference synthesized image with the reference file image.

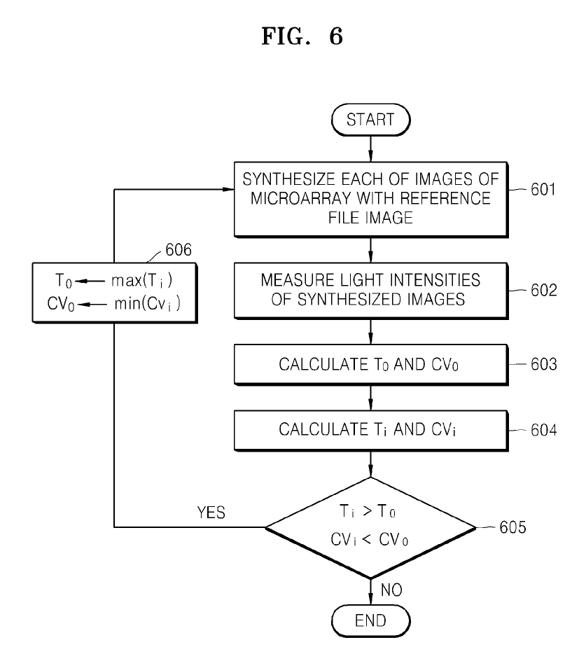

FIG. 6 is a flowchart of an embodiment in which a T-test statistic and a CV are applied to the operations 501 through to 505 illustrated in FIG. 5. Referring to FIG. 6, the statistics of a reference synthesized image from among the synthesized images obtained by the image synthesis unit 205 and the statistics of some of the synthesized images other than the reference synthesized image are calculated, and the statistics of the reference synthesized image is compared with the statistics of each of the some of the synthesized images.

In operation 601, the image synthesis unit 205 synthesizes each of the images of the microarray 201 with the reference file image.

In operation 602, the light intensity measuring unit 301 measures light intensities of the positions of BF spots of the reference file image, light intensities of the positions of DF spots of the reference file image, and light intensities of the positions of data spots of the reference file image in the synthesized images obtained by the image synthesis unit 205.

In operation 603, the calculation unit 302 calculates statistics corresponding to the light intensities of the reference synthesized image, which are measured by the light intensity measuring unit 301. T₀ denotes a T-test statistic of the reference synthesized image, and CV₀ denotes a CV of the reference synthesized image.

In operation 604, the calculation unit 302 calculates statistics corresponding to the light intensities of the some synthesized image, which are measured by the light intensity measuring unit 301. Referring to operation 604, Tᵢ and CVᵢ (where i varies from 1 to i) in each of i synthesized images denote a T-test statistic and a CV, respectively. For example, T₁ and CV₁ denote statistics corresponding to a first synthesized image of synthesized images, and T₂ and CV₂ denote statistics corresponding to a second synthesized image of the synthesized images.

In operation 605, the comparison unit 303 compares the statistics of the reference synthesized image with the statistics of each of the some synthesized images. In an embodiment, T₀ and CV₀, which are the statistics of the reference synthesized image, are compared with Tᵢ and CVᵢ, which are statistics of an i-th synthesized image of the synthesized images. As the T-test statistic is larger and the CV is smaller, it is considered that the positions of data spots of the synthesized images which are compared have been more accurately detected. For example, if the number of some synthesized images is 16, T₀ is compared with T₁ through to T₁₆ and CV₀ is compared with CV₁ through to CV₁₆. If Tₒ, which corresponds to the T-test statistic of the reference synthesized image, is not less than Tᵢ and CV₀, which corresponds to the CV of the reference synthesized image, is not greater than CVᵢ, the reference synthesized image is selected. Otherwise, the method repeats the operation 606.

In operation 606, when there exists a synthesized image having a Tᵢ greater than T₀ and a CVᵢ less than CV₀ from among the some synthesized images, the Tᵢ and the CVᵢ are set as new T₀ and CV₀ because the synthesized image having Ti and CVi has data spots whose positions are detected more accurately than the reference synthesized image. This set of the Tᵢ and the CVᵢ as the new T₀ and CV₀ corresponds to an update of the reference synthesized image with the synthesized image having Tᵢ and CVᵢ. After the reference synthesized image is updated with the synthesized image having Tᵢ and CVᵢ as an updated reference synthesized image, compared synthesized images that have already compared with the previous reference synthesized image are updated with some of the synthesized images obtained by synthesizing some of the images of the microarray 201 corresponding to a new reference synthesized image with the reference file image. Updated synthesized images that are obtained by updating the compared synthesized images are obtained by moving an image of the microarray 201 synthesized with the reference file image to different positions to obtain the updated reference synthesized image. In an embodiment, the image synthesis unit 205 synthesizes images of the microarray 201 updated by the update unit 304 and obtained by being moved to the different positions with the reference file image, and updates the compared synthesized images that have already compared with the reference synthesized image with new synthesized images. When a synthesized image other than the updated reference synthesized image satisfies the condition of the operation 605, the operations of measuring the light intensities of the some of the synthesized images, calculating the statistics of the some of the synthesized images, comparing the statistics of each of the some of the synthesized images with the statistics of the new reference synthesized image, and performing update are repeated until a newly updated reference synthesized image is selected.

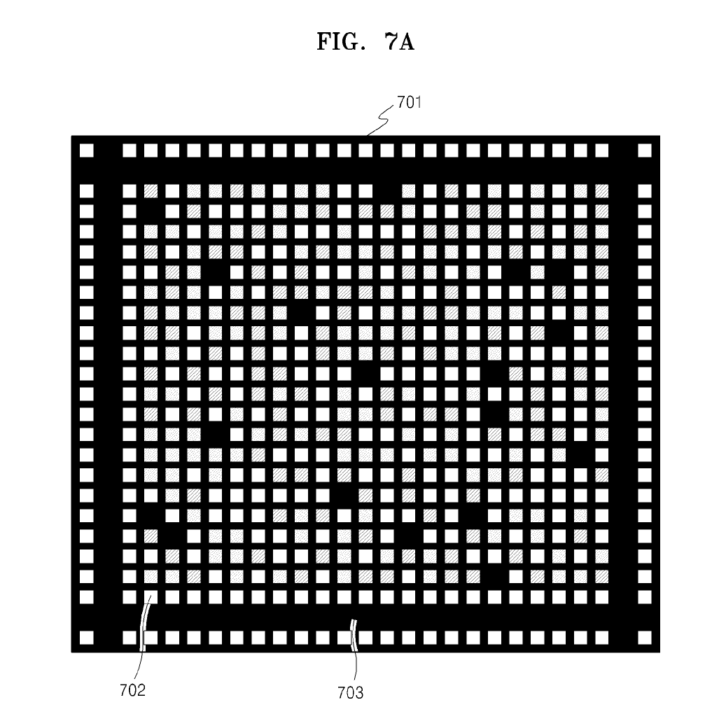

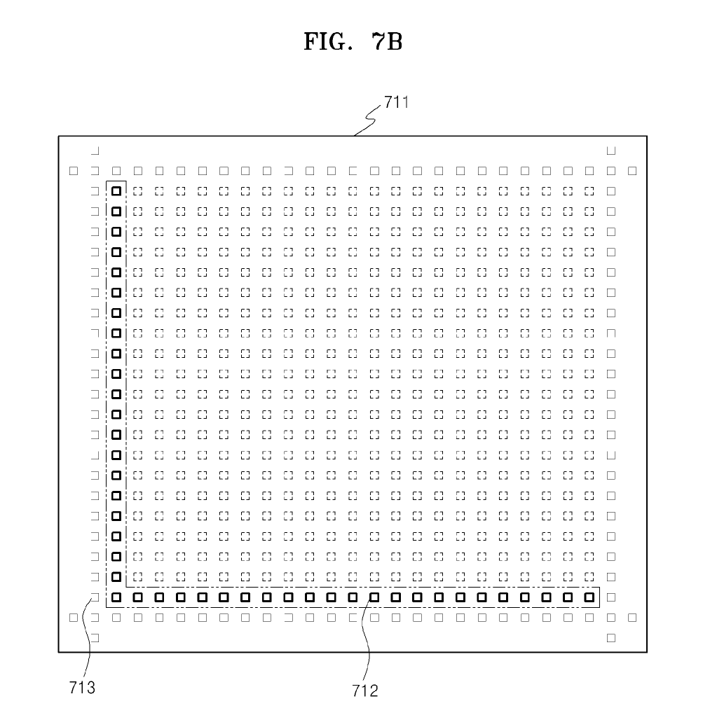

FIGS. 7A and 7B are plan views that illustrate an embodiment of a single panel 701 within a microarray and a reference file image 711. Although the panel 701 is illustrated as a rectangle in FIG. 7A, the panel 701 may have other shapes such as a polygon, a circle, and other similar shapes, for example.

As shown in FIG. 7A, the panel 701 includes data spots, BF spots 702, and DF spots 703.

The BF spots 702 of the panel 701 are disposed in an “L” shape, and the DF spots of the panel 701 are disposed in a rectangular rim shape. Spots other than the BF and DF spots 702 and 703 correspond to the data spots.

As shown in FIG. 7B, the reference file image 711 includes data spots, BF spots 712, and DF spots 713.

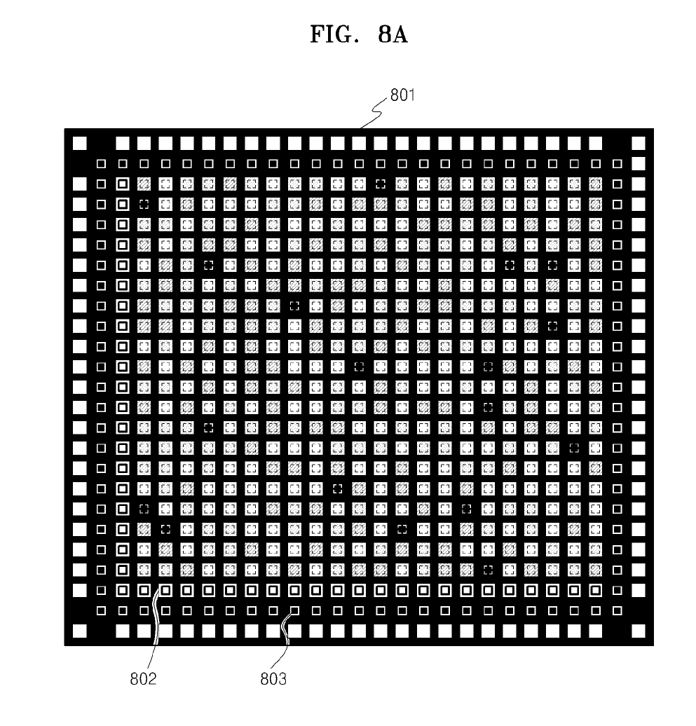

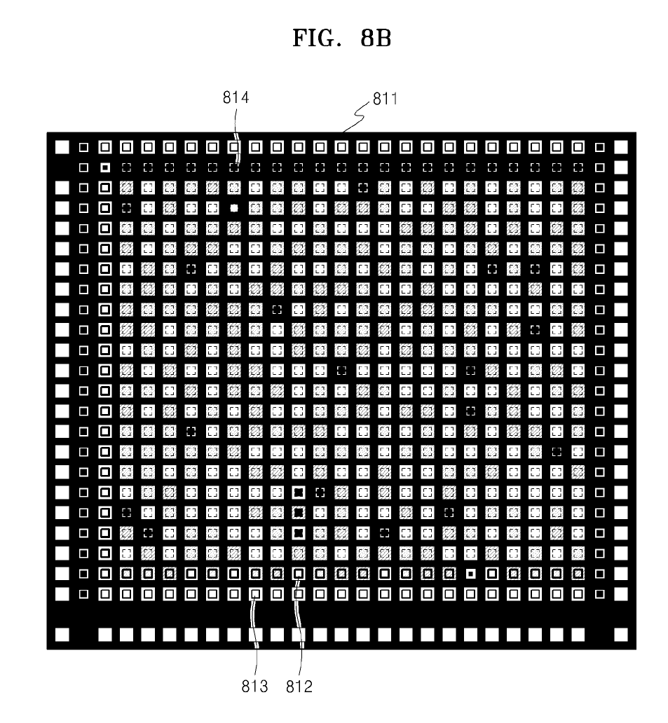

FIGS. 8A and 8B are plane views that illustrate embodiments of synthesized images in which positions of data spots are detected from the synthesized images obtained by the image synthesis unit 205. The synthesized images are obtained by synthesizing the images of FIGS. 7A and 7B.

FIG. 8A illustrates an embodiment of a synthesized image in which positions of data spots are accurately detected from a single panel 801. As illustrated in DF spots 803 having a rectangular rim shape, BF spots 802 having an “L” shape and data spots, the positions of spots disposed on an actual microarray may accurately match with the positions of spots formed on a reference file image.

FIG. 8B illustrates an embodiment of a synthesized image in which positions of data spots are inaccurately detected from a single panel 811. As shown in FIG. 8B, in the synthesized image, DF spots 813 of a reference file image are positioned one spot line upward from the DF spots of a microarray, BF spots 812 of the reference file image are positioned one spot line upward from the BF spots of the microarray, and data spots 814 of the reference file image overlap the DF spots of the microarray. Accordingly, the positions of the data spots of the microarray do not coincide with the positions of the data spots of the reference file image, and thus a target material may not be accurately analyzed although a signal obtained from each data spot is analyzed.

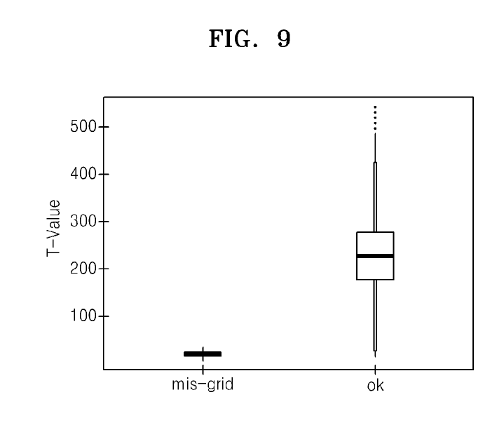

FIG. 9 is a graph illustrating T-values calculated by an embodiment of the calculation unit 302 included in the apparatus 200 shown in FIG. 2. As shown in FIG. 9, a “mis-grid” case where the positions of data spots are inaccurately detected and an “ok” case where the positions of data spots are accurately detected are illustrated on x-axis, and y-axis indicates corresponding T-values, which represents a T-test statistic. As described above, the positions of data spots are more accurately detected from synthesized images having large T values than from synthesized images having small T values. In other words, referring to FIG. 9, the T-value in the “ok” case where the positions of data spots are accurately detected is larger than in a T-value in the “mis-grid” case where the positions of data spots are inaccurately detected.

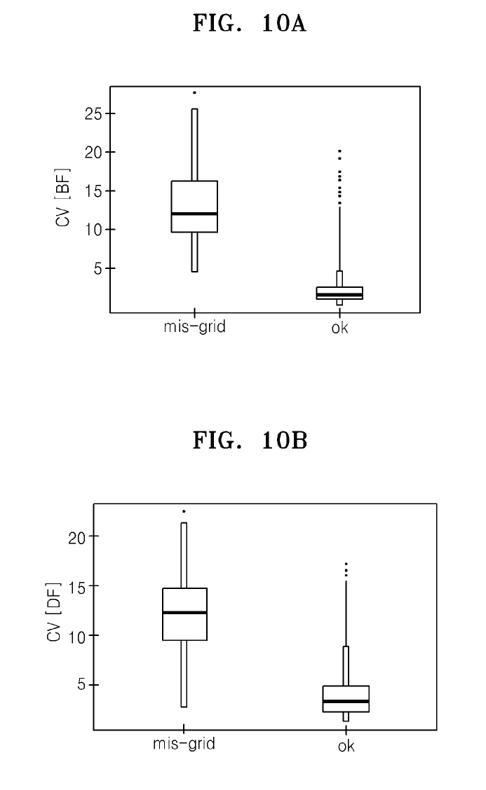

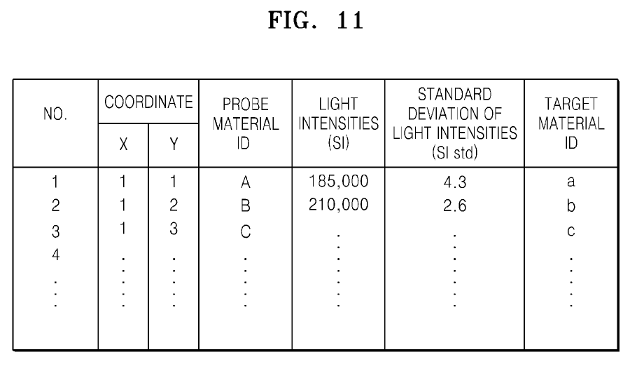

FIG. 10A is a graph illustrating CV of light intensities of BF spots, CV[BF], calculated in an embodiment of the calculation unit 302 of the apparatus 200 illustrated in FIG. 2. FIG. 10B is a graph illustrating CV of light intensities of DF spots, CV[DF], calculated in an embodiment of the calculation unit 302 of the apparatus 200 illustrated in FIG. 2. As shown in FIGS. 10A and 10B, the “mis-grid” case where the positions of data spots are inaccurately detected and the “ok” case where the positions of data spots are accurately detected are illustrated on x-axes. Y-axes of FIGS. 10A and 10B corresponds to the CV of BF spots, CV[BF], and the CV of DF spots, CV[DF], respectively. As described above, the positions of data spots are more accurately detected from synthesized images having small CVs than from synthesized images having large CVs. In an embodiment, referring to FIG. 10A, the CV of BF spots, CV[BF], is smaller in the “ok” case where the positions of data spots are accurately detected than in the “mis-grid” case where the positions of data spots are inaccurately detected. Referring to FIG. 10B, the CV of DF spots, CV[DF], is smaller in the “ok” case where the positions of data spots are accurately detected than in the “mis-grid” case where the positions of data spots are inaccurately detected.

FIG. 11 illustrates an embodiment of a reference file according to the present invention. As shown in FIG. 11, information about coordinates allocated to a reference file image is stored as a file. For example, the information includes probe materials, fiducial spots, and light intensities of the coordinates and a standard deviation of the light intensities. However, other pieces of data may be included in the information.

As described above, according to the one or more embodiments of the present invention, positions of data spots of a microarray may be detected from microarrays including various configurations of fiducial spots. In addition, since the positions of the data spots may be detected from a microarray including a small number of fiducial spots, more data spots may be secured.

An embodiment of the present invention may be written as computer programs and can be implemented in general-use digital computers that execute the programs using a computer readable recording medium. A data structure used in the embodiments may be recorded on the computer readable recording medium using various devices and methods. Examples of the computer readable recording medium include magnetic storage media, e.g., read-only memory (“ROM”), floppy disks, hard disks, and optical recording media, e.g., compact disc read-only memories (“CD-ROMs”) and digital versatile discs (“DVDs”).

The present invention should not be construed as being limited to the embodiments set forth herein. Rather, these embodiments are provided so that this disclosure will be thorough and complete and will fully convey the concept of the present invention to those of ordinary skill in the art.

While the present invention has been particularly shown and described with reference to embodiment thereof, it will be understood by those of ordinary skill in the art that various changes in form and detail may be made therein without departing from the spirit or scope of the present invention as defined by the following claims.

What is claimed is:

1. A method of detecting positions of data spots on a microarray, the method comprising:
generating synthesized images by synthesizing images of the microarray with a grid-pattern image to distinguish spots on the microarray;
selecting a synthesized image from the synthesized images based on statistics corresponding to light intensities of fiducial spots included in the synthesized images; and
detecting the positions of the data spots based on the synthesized image selected from the synthesized images.

2. The method of claim 1, wherein one of the images of the microarray is an image detected from the microarray, and another of the images of the microarray is an image obtained by moving the one of the images of the microarray to a different position.

3. The method of claim 1, wherein the statistics include at least one of statistics corresponding to differences between light intensities of the fiducial spots of the synthesized images and statistics corresponding to uniformities between the light intensities of the fiducial spots of the synthesized images.

4. The method of claim 3, wherein:
the fiducial spots include first type fiducial spots and second type fiducial spots; and
the statistics include at least one of statistics corresponding to a difference between light intensities of the first type fiducial spots and light intensities of the second type fiducial spots and statistics corresponding to a uniformity between the light intensities of the first type fiducial spots and uniformity between the light intensities of the second type fiducial spots.

5. The method of claim 3, wherein
the selecting the synthesized image from the synthesized images further comprises:
comparing statistics of each of the synthesized images with each other, the statistics corresponding to light intensities of fiducial spots corresponding to each of the synthesized images; and
selecting a synthesized image having at least one of a statistic indicating that a difference between the light intensities of the fiducial spots is the greatest and a statistic indicating that the light intensities of the fiducial spots are the most uniform from among the synthesized images.

6. The method of claim 5, wherein:
the comparing the statistics of the each of the synthesized images includes comparing statistics of a reference synthesized image from among the synthesized images with statistics of each of some of the synthesized images; and
the selecting the synthesized image from the synthesized images includes selecting the synthesized image when the reference synthesized image has at least one of a statistic indicating that a difference between the light intensities of the fiducial spots is the greatest and a statistic indicating that the light intensities of the fiducial spots are the most uniform.

7. The method of claim 6, wherein:
the selecting the synthesized image from the synthesized images further includes:
setting one of the synthesized images other than the reference synthesized image as a new reference synthesized image when the one of the synthesized images other than the reference synthesized image has at least one a statistic indicating that a difference between the light intensities of the fiducial spots is the greatest and a statistic indicating that the light intensities of the fiducial spots are the most uniform; and
replacing some of the synthesized images with new synthesized images obtained by synthesizing some of images obtained based on the new reference synthesized image with the grid-pattern image, and
the selecting the image from the synthesized images is repeated on the new synthesized images until the new reference synthesized image has at least one of a statistic indicating that a difference between the light intensities is the greatest and a statistic indicating that the light intensities are the most uniform.

8. The method of claim 7, wherein a synthesized image obtained by synthesizing an image detected from the microarray with the grid-pattern image from among the synthesized images is an initial reference synthesized image.

9. The method of claim 7, wherein the images obtained based on the new reference synthesized image are images obtained by moving an image of the microarray synthesized with the grid-pattern image to form the new reference synthesized image to a different position.

10. The method of claim 5, wherein:
the comparing the statistic of the each of the synthesized images includes comparing statistics of all of the synthesized images; and
the selecting the synthesized image from the synthesized images includes selecting the synthesized image from the synthesized images when one of the synthesized image has at least one of a statistic indicating that a difference between the light intensities is the greatest and a statistic indicating that the light intensities are the most uniform.

11. A computer program product comprising a computer readable computer program code for executing a method of detecting positions of data spots on a microarray, the method comprising:
generating synthesized images by synthesizing images of the microarray with a grid-pattern image to distinguish spots on the microarray;
selecting a synthesized image from the synthesized images based on statistics corresponding to light intensities of fiducial spots included in the synthesized images; and
detecting the positions of the data spots based on the synthesized image selected from the synthesized images.

12. An apparatus for detecting positions of data spots on a microarray, the apparatus comprising:
an image synthesis unit which synthesizes images of the microarray with a grid-pattern image to distinguish spots on the microarray and generate synthesized images;
a selection unit which selects a synthesized image from the synthesized images based on statistics corresponding to light intensities of fiducial spots included in the synthesized images; and
an output unit which detects the positions of the data spots from the synthesized image selected by the selection unit.

13. The apparatus of claim 12, wherein one of the images of the microarray is an image detected from the microarray, and others of the images of the microarray are images obtained by moving the one of the images of the microarray detected from the microarray to a different position.

14. The apparatus of claim 12, wherein the statistics include at least one of statistics corresponding to differences between light intensities of the fiducial spots of the synthesized images and statistics corresponding to uniformities between the light intensities of the fiducial spots of the synthesized images.

15. The apparatus of claim 14, wherein:
the fiducial spots include first type fiducial spots and second type fiducial spots; and
the statistics include at least one of a statistic corresponding to differences between light intensities of the first type fiducial spots and light intensities of the second type fiducial spots and statistics corresponding to a uniformity between the light intensities of the first type fiducial spots and a uniformity between the light intensities of the second type fiducial spots.

16. The apparatus of claim 14, wherein:
the selection unit further comprises a comparison unit which compares a statistic of each of the synthesized images with one another, wherein the statistic corresponds to the light intensities of the fiducial spots included in the each of the synthesized images; and
the selection unit selects a synthesized image having at least one of a statistic indicating that a difference between the light intensities of the fiducial spots is the greatest and a statistic indicating that the light intensities of the fiducial spots is the most uniform from among the synthesized images.
